(19) United States
(12) Patent Application Publication
(10) Pub. No.: US 2016/0195830 A1
(43) Pub. Date: Jul. 7, 2016

(54) PROCESS CARTRIDGE, IMAGE FORMING APPARATUS WITH PROCESS CARTRIDGE, AND METHOD OF FORMING IMAGE BY USING IMAGE FORMING APPARATUS WITH PROCESS CARTRIDGE

(71) Applicants: Hideyasu Seki, Chiba (JP); Satoshi Hatori, Kanagawa (JP); Takeshi Fukao, Kanagawa (JP); Yuta Kawashima, Kanagawa (JP)

(72) Inventors: Hideyasu Seki, Chiba (JP); Satoshi Hatori, Kanagawa (JP); Takeshi Fukao, Kanagawa (JP); Yuta Kawashima, Kanagawa (JP)

(73) Assignee: Ricoh Company, Ltd., Tokyo (JP)

(21) Appl. No.: 14/987,498

(22) Filed: Jan. 4, 2016

(30) Foreign Application Priority Data
Jan. 5, 2015 (JP) 2015000340

(51) Int. Cl. G03G 15/02

(52) U.S. Cl. CPC G03G 15/0266

(57) ABSTRACT

In an image forming apparatus, an electric charging member, spaced apart from an image bearer across an electric charge gap, electrically charges the image bearer uniformly across the electric charge gap. A voltage applying device applies a voltage to the electric charging member. A cleaner collects residual toner remaining on the image bearer therefrom after a transfer device transfers a toner image onto a recording medium. An electric charge gap maintaining device forms and keeps constant the electric charge gap between the electric charging member and the image bearer. A calculating device calculates a value of discharge current to be generated by the electric charging member. A processor controls the voltage applying device to vary a voltage applied to the electric charging device to render the value of discharge current calculated by the calculating device substantially constant.

### CROSS-REFERENCE TO RELATED APPLICATION

This patent application is based on and claims priority pursuant to 35 U.S.C. §119(a) to Japanese Patent Application No. 2015-000340, filed on Jan. 5, 2015, in the Japan Patent Office, the entire disclosure of which is hereby incorporated by reference herein.

### BACKGROUND

1. Technical Field

Embodiments of the present invention relate to an image forming apparatus, such as a copier, a printer, a scanner, a facsimile machine, a multifunction peripheral having multiple functions of these devices, etc., a process cartridge detachably attached to the image formation apparatus, and a method of forming an image with the image forming apparatus.

2. Related Art

Hitherto, as an electric charging device employed in the image forming apparatus, a corona discharge system is widely used. However, because it discharges a relatively small amount of corona products, such as ozone, etc., a short range discharging system is widely used as well.

An electric charging roller is one example of an electric charging device that employs the short range discharging system. Although originally configured to be used while contacting an image bearer (for example, a photoconductor), a contemporary electric charging roller that is separated from the image bearer is now commercially available (hereinafter simply referred to as a non-contact type electric charging roller).

The non-contact type electric charging roller is constructed of a pair of gap holders, such as spacers, tapes, etc., each having a prescribed thickness and attached to the two ends of an elastic roller portion of the electric charging roller. Hence, a portion of the electric charging roller other than the pair of gap holders is separated from a surface of the image bearer and electrically charges the surface of the image bearer in such separated state. The electric charging device, like the electric charging roller or the like that employs the short range discharging system, generally discharges a relatively small amount of corona products, such as ozone, etc. In addition, since the electric charging roller that electrically charges the surface of the image bearer is separated from the surface of the image bearer, the surface of the electric charging roller is not heavily contaminated by transfer residual toner remaining on the surface of the image bearer after a toner transfer process of transferring a toner image is executed. That is, even if it remains on the surface of the image bearer after the toner transfer process is executed, the transfer residual toner is not transferred onto the surface of the electric charging roller, so the electric charging roller can maintain a prescribed level of electric charging performance at the same time as well.

With the non-contact type electric charging roller, because it is separated from the photoconductor, deposits passing through a cleaning section are prevented from traveling to and contacting the electric charging roller, thereby prolonging the life of the electric charging roller accordingly. However, electric charge irregularity sometimes occurs when abnormal discharge occurs, resulting in problems such as poor image quality, etc. Such a problem of the non-contact type electric charging roller tends to be more likely to occur as a size of an electric charge gap increases.

In addition, although the non-contact type electric charging roller does not contact the photoconductor and is rarely stained even as time elapses, because the non-contact type electric charging roller employs a pair of gap rollers to control the size of the gap formed between the photoconductor and the electric charging roller and a layer thickness of each of the pair of gap rollers varies, either a shaft of the electric charging roller deflects (i.e., deviates from a central axis thereof) or vibrates around the central axis thereof thereby causing irregular discharge again when the non-contact type electric charging roller rotates. To avoid this problem, a conventional electric charge control system determines a target current value based on a condition in which electric charge current flows least such as when the shaft of the electric charging roller deflects and vibrates greatly at the same time. Such a target electric charge current value is utilized in determining an applied voltage Vpp commonly applied to various electric charging rollers in which the shaft of the electric charging roller deflects and vibrates differently. Consequently, when a stable electric charging roller the shaft of which deflects and vibrates only slightly, the electric charge current is too large. As a result, since hazards to the photoconductor grow when such a stable electric charging roller is used, abnormal deposits, such as killifish-shaped filming (i.e., elongate fixation of toner in the shape of a killifish that occurs in the direction of rotation of the photoconductor), etc., easily adhere to the photoconductor, thereby sometimes producing an abnormal image.

### SUMMARY

Accordingly, one aspect of the present invention provides a novel image forming apparatus that includes an image bearer to bear an image thereon, an electric charging member, spaced apart from the image bearer across an electric charge gap, to electrically charge the image bearer uniformly across the electric charge gap, and a voltage applying device to apply a voltage to the electric charging member. The image forming apparatus also includes a writing device to write and form an electrostatic latent image on the image bearer, a developing device to render the electrostatic latent image visible as a toner image, and a transfer device, disposed in a transfer section of the image formation apparatus, to transfer the toner image rendered visible by the developing device onto a recording medium. Further included in the novel image forming apparatus are a cleaner to collect residual toner remaining on the image bearer therefrom after the transfer device transfers the toner image onto the recording medium, an electric charge gap maintaining device to form and keep constant the electric charge gap between the electric charging member and the image bearer, and a calculating device to calculate a value of discharge current to be generated by the electric charging member. Further included in the novel image forming apparatus is a processor to control the voltage applying device to vary a voltage applied to the electric charging device to render the value of discharge current calculated by the calculating device substantially constant.

Another aspect of the present invention provides a process cartridge detachably attached to be used in the image forming apparatus. The process cartridge accommodates at least the image bearer and the cleaner to clean the image bearer as a unit.

Yet another aspect of the present invention provides a novel method of forming an image. The method includes the steps of bearing an image on an image bearer having a secondary moment of area and a length with a quotient of the secondary moment of area divided by a third power of the length ranging from about 0.00005 to about 0.00015, electrically charging the image bearer uniformly with an electric charging member across an electric charge gap, and applying a voltage to the electric charging member with a voltage applying device. The method further includes the steps of optically writing and forming an electrostatic latent image on the image bearer with an optical writing unit, rendering the electrostatic latent image visible as a toner image with a developing device, and transferring the toner image rendered visible during the step of rendering the electrostatic latent image visible with the developing device onto a recording medium with a transfer device disposed in a transfer section. The method further includes the steps of collecting residual toner remaining on the image bearer with a cleaner therefrom after the step of transferring the toner image onto a recording medium with a transfer device, forming and keeping constant the electric charge gap between the electric charging member and the image bearer with an electric charge gap maintaining device, and calculating a value of discharge current to be generated by the electric charging member with a calculating device. The method further includes the step of controlling the voltage applying device with a processor to vary and apply the voltage to the electric charging member to render the value of discharge current constant based on a result of calculation executed during the step of calculating the value of discharge current to be generated by the electric charging member with the calculating device.

### BRIEF DESCRIPTION OF THE DRAWINGS

A more complete appreciation of the present invention and many of the attendant advantages thereof will be more readily obtained as substantially the same becomes better understood by reference to the following detailed description when considered in connection with the accompanying drawings, wherein:

FIG. 1 is a cross-sectional view schematically illustrating an exemplary image forming apparatus according to one embodiment of the present invention;

FIG. 2 is a diagram illustrating a configuration of an exemplary image forming unit included in the image forming apparatus, in which an electric charging roller is located below a photoconductor (i.e., at a bottom portion of the image forming unit) according to one embodiment of the present invention;

FIG. 3A is a cross-sectional view illustrating an exemplary image forming apparatus, in which various embodiments of the present invention are implemented, according to one embodiment of the present invention;

FIG. 3B is a cross-sectional view illustrating an exemplary photoconductor in a deflected state and an amount of deflection of the photoconductor included in the image forming apparatus, in which various embodiments of the present invention are implemented, according to one embodiment of the present invention;

FIG. 4 is a cross-sectional view illustrating another exemplary image forming apparatus, in which various embodiments of the present invention are implemented again, according to another embodiment of the present invention;

FIG. 5A is a graph illustrating an exemplary relation between an output voltage and an output current obtained when an electric charge gap is at an upper tolerance limit according to one embodiment of the present invention;

FIG. 5B is also a graph illustrating an exemplary relation between an output voltage and an output current obtained when the electric charge gap is at a lower tolerance limit according to another embodiment of the present invention;

FIG. 6A is a graph illustrating an exemplary relation between an output voltage and a discharge current obtained when the electric charge gap is at the upper tolerance limit according to one embodiment of the present invention;

FIG. 6B is also a graph illustrating an exemplary relation between an output voltage and a discharge current obtained when the electric charge gap is at the lower tolerance limit according to another embodiment of the present invention;

FIG. 7 is a graph illustrating an exemplary approximation straight line representing a relation between an applied voltage Vpp and an output current value (i.e., Vpp/Output current), which is drawn at a linear portion of a function curve that represents the relation between the output voltage and the output current obtained when the electric charge gap is at the upper tolerance limit as shown in FIG. 5A according to one embodiment of the present invention;

FIG. 8 is a block chart schematically illustrating an exemplary control system that controls operation of the electric charging roller in the image forming apparatus according to one embodiment of the present invention;

FIG. 9 is a cross-sectional view schematically illustrating an exemplary drum-shaped electric charging roller employed in the image forming apparatus according to one embodiment of the present invention; and

FIG. 10 is a cross-sectional view schematically illustrating another exemplary image forming apparatus, in which various embodiments of the present invention are implemented, according to one embodiment of the present invention.

### DETAILED DESCRIPTION

Although the hazard to the photoconductor can be reduced as time elapses, the gap size variation and the deflection of the electric charging roller in the circumferential direction each caused in an initial stage of operation cannot be suppressed. When the electric charging roller is arranged with the small gap while causing the small deflection in the circumferential direction, the discharge current is continuously excessive from the beginning, and accordingly, the hazard to the photoconductor remains great thereby possibly raising a problem again.

Even though it is the most serious problem when a non-contact type electric charging system that employs a gap roller is used together with an organic photoconductor acting as an image bearer (hereinafter simply referred to as an OPC) that generates large deflection, there does not exist an effective countermeasure against gap size variation in a longitudinal direction of an electric charging roller. In addition, with the non-contact type electric charging system, an applied voltage Vpp is not optimally controlled in accordance with the gap size variation in the circumferential direction of the electric charging roller as well.

To further downsize and save weight of a process cartridge unit while obtaining multi-functionality (e.g. usage of an expanded paper sheet slightly larger than an A3 sized paper sheet (JIS (Japanese Industrial Standard))), a new photoconductor is demanded recently. That is, although a diameter of the gap roller generally fluctuates thereby causing deflection of the gap roller in a circumferential direction thereof, the non-contact type electric charging roller with such a gap roller is expected not to excessively discharge in both longitudinal and circumferential directions thereof while avoiding a discharge error even when a small-diameter, thin, and continuous-paper-sheet-accommodating photoconductor (i.e., a high-performance and a low-cost photoconductor) is used therewith.

However, the gap size variation necessarily occurs (between these rollers) in the longitudinal direction of them when the small-diameter, thin, and continuous-paper-sheet-accommodating photoconductor is used, and accordingly, an appropriate value of discharge current cannot be supplied over the entire region thereof in the longitudinal direction. Similarly, an appropriate value of discharge current is not supplied to the photoconductor in the circumferential direction thereof as well. As a result, a discharge value lacks and gives rise to an abnormal image, such as a spotty image, etc., at a central portion of an image in a longitudinal direction thereof, at which the gap becomes relatively great. Otherwise, the discharge value becomes excessive and causes deposits on the OPC, thereby again giving rise to the abnormal image, such as a dropout image, etc., at the central portion of an image in the longitudinal direction thereof as well.

The present invention is made in view of the above described various problems, and it is an object of the present invention to reduce an amount of stain on an electric charging member and enable an image forming apparatus to output a fine image for a long time by reducing deflection of an electric charge gap in both longitudinal and circumferential directions, thereby preventing occurrence of an abnormal image.

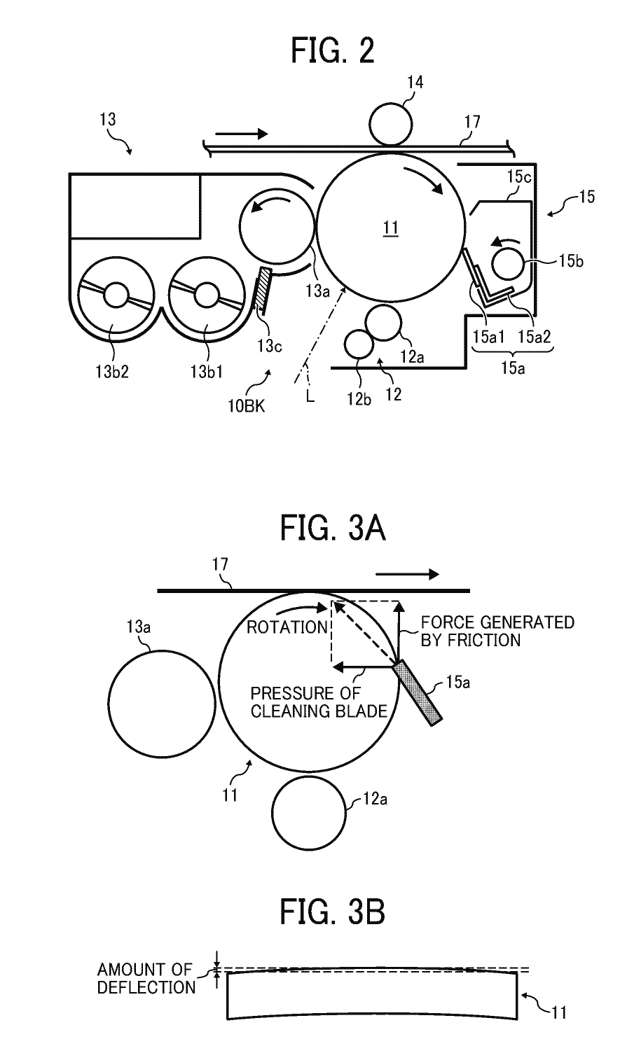

Referring now to the drawings, wherein like reference numerals designate identical or corresponding parts throughout the several views thereof, and in particular to FIGS. 2 to 3B, one embodiment of the present invention is herein below described. As shown there, an image forming apparatus (i.e., an apparatus main body 1) includes an image bearer 11 having a secondary moment of area and a length so that a quotient of the secondary moment of area divided by a third power of the length ranges from about 0.00005 to about 0.00015. The image forming apparatus also includes an electric charging roller 12a to electrically charge the image bearer 11 uniformly across an electric charge gap, a voltage applying device to apply a voltage to the electric charging roller 12a, and a writing device to emit light L to write and form an electrostatic latent image on the image bearer 11. The image forming apparatus further includes a developing unit 13 (including a developing roller 13a) to render the electrostatic latent image visible as a toner image, a transfer device 14 disposed in a transfer section to transfer the toner image rendered visible by the developing unit 13 (i.e., the developing roller 13a) onto an intermediate transfer belt 17 as a recording medium, and a cleaning unit 15 acting as a cleaner to collect residual toner remaining on the image bearer 11 therefrom after the transfer device 14 transfers the toner image onto the intermediate transfer belt 17 as a recording medium. An electric charge gap maintaining device is provided to form and keep constant the electric charge gap between the electric charging roller 12a and the image bearer 11. A calculating device is provided to calculate a value of discharge current to be generated by the electric charging roller 12a. A processor controls the voltage applying device to vary a voltage applied to the electric charging roller 12a to render the value of discharge current calculated by the calculating device substantially constant.

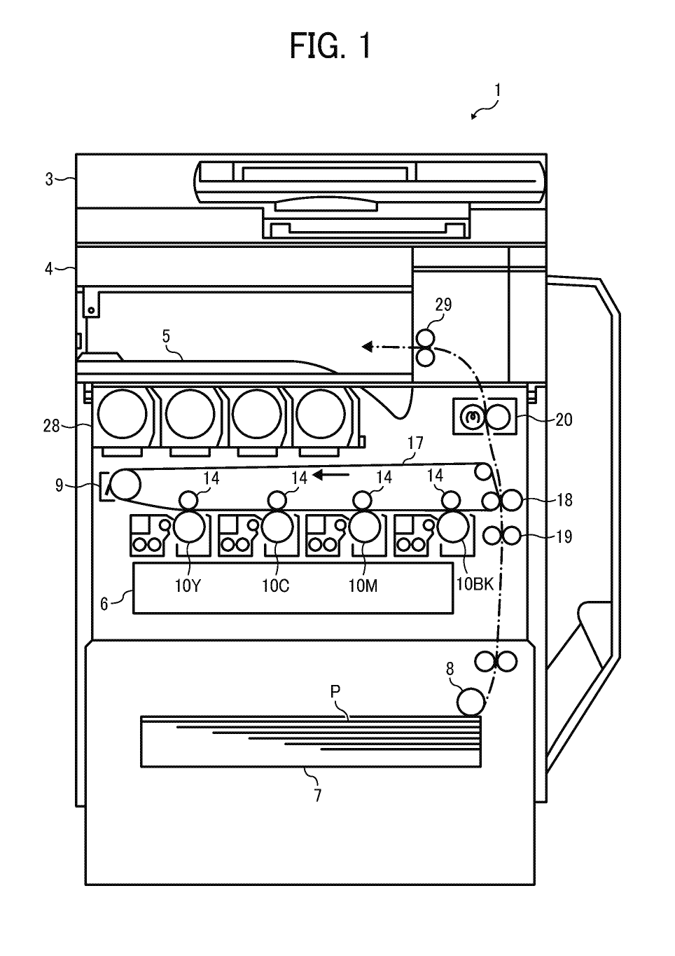

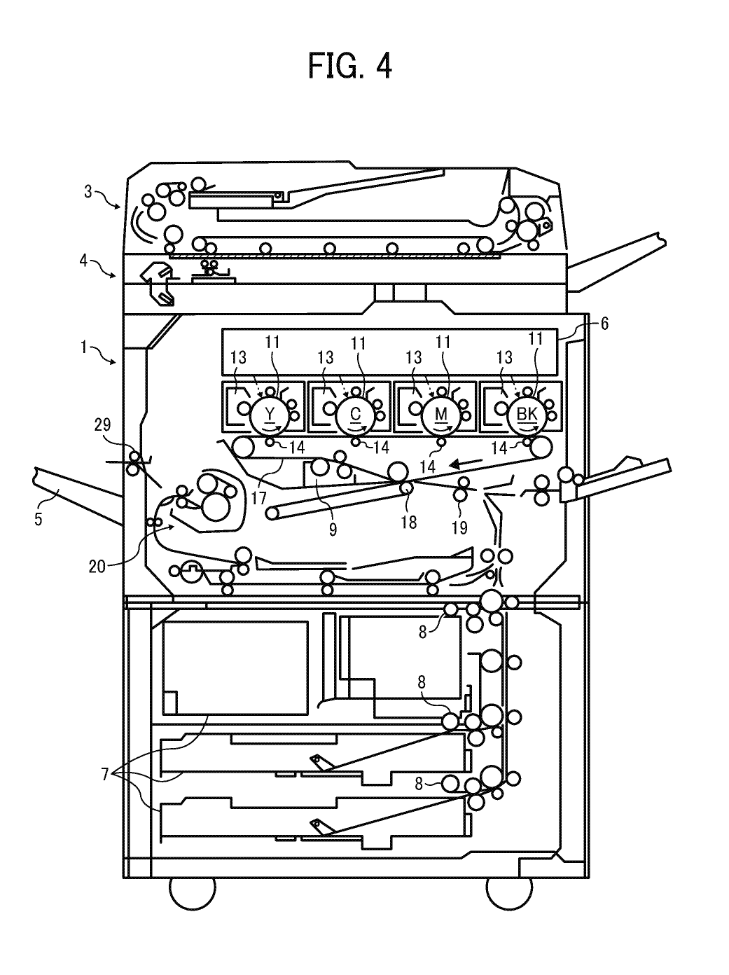

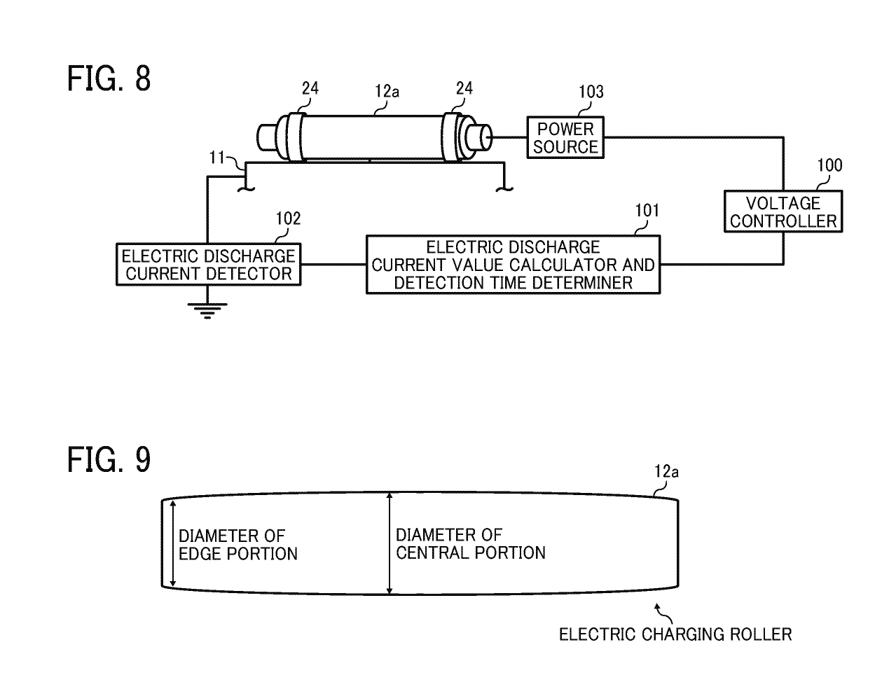

Specifically, as shown in FIGS. 1 to 4, an electric charging unit 12 includes the electric charging roller 12a. The electric charging roller 12a desirably has a roller shape and is constituted by at least a metal core acting as a conductive substrate, an electric charging body made of resin including ion-conductive material, and a pair of gap holders 24 (see FIG. 8) made of insulating resin placed at both ends of the electric charging body to contact the image bearer 11 to form a gap between the electric charging body and the image bearer 11. A lubrication supply device 33 and 39 (including a lubricant coating member 33a, a lubricant 33b, a lubricant biasing member 33d, a lubricant holder 33e, a coating blade 39a, and a coating blade holder 39b) is also desirably employed in the electric charging unit 12 to supply lubricant 33b to the image bearer 11. A lubricant supply amount control device is also desirably employed in the electric charging unit 12 to increase an amount of lubricant 33b supplied to the image bearer 11 from the lubricant supply device 33 and 39 at the same time when the above-described value of discharge current is corrected. Here, the lubricant coating blade 39a supplied to the image bearer 11 may contain at least zinc stearate. The image bearer 11 may be an organic photoconductor and may include a protective layer on a front surface of the organic photoconductor to reduce a degree of wear thereof. Metal oxide may be dispersed into the protective layer as well.

Referring now to FIGS. 1 and 2, multiple cross-sectional views of an exemplary image forming apparatus (included in the apparatus main body 1) of one embodiment of the present invention are specifically described, respectively. Initially, the entire configuration and operation of the image forming apparatus are briefly described with reference to in FIG. 1. As shown there, the image forming apparatus is a tandem type color image forming apparatus, in which multiple process cartridges 10Y, 10M, 10C, and 10BK acting as multiple image forming units are arranged side by side while facing an intermediate transfer belt 17.

Specifically, in FIG. 1, a reference numeral 1 indicates the main unit of a color copier as an image forming apparatus, a reference numeral 4 indicates a document reader 4 that reads image information of a document, and a reference numeral 3 indicates a document feeder that conveys the document to a document reader 4. A reference numeral 6 indicates an optical writing unit (i.e., an exposing unit) that emits laser light based on image data input thereto. A reference numeral 7 indicates a paper sheet feeder that stores multiple recording media P, such as transfer paper sheets, etc. Multiple reference numerals 10Y, 10M, 10C, and 10BK indicate process cartridges as image forming units for multiple component colors (yellow, magenta, cyan, and black), respectively. A reference numeral 17 also indicates the intermediate transfer belt (i.e., an intermediate transfer member), onto which more than two color toner images are transferred and superimposed one by one, thereby forming a full-color toner image. A reference numeral 18 indicates a secondary transfer roller that secondarily transfers the full-color toner image formed and borne on the intermediate transfer belt 17 onto a recording medium P therefrom. A reference numeral 20 indicates a fixing device that fixes an unfixed toner image borne on the recording medium P thereinto. A reference numeral 28 also indicates toner containers to supply toner of respective component colors to the corresponding developing units 13 included in the respective process cartridges 10Y, 10M, 10C, and 10BK.

Here, each of the process cartridges 10Y, 10M, 10C, and 10BK (i.e., multiple image forming units) is configured by integrating a photoconductor 11 acting as an image bearer 11, an electric charging unit 12, the developing device (i.e., a developing unit) 13, and a cleaning unit 15 (i.e., a cleaning unit) with each other as shown in FIG. 2. Each of the process cartridges 10Y, 10M, 10C, and 10BK is replaced with a new process cartridge at the end of life of each of those. In the process cartridges 10Y, 10M, 10C, and 10BK, multiple toner images of component colors (yellow, magenta, cyan, and black) are formed on the photoconductors 11 (i.e., image bearers 11), respectively.

Herein below, exemplary operation of the image forming apparatus executed when the image forming apparatus forms an ordinary color image is described with reference to applicable drawings. First, a document is fed from a document setting table by a conveyance roller provided in the document feeder 3 and is placed on a contact glass provided in the document reader 4. Then, in the document reader 4, image information of the document placed on the contact glass is optically read. More specifically, in the document reader 4, the image of the document placed on the contact glass is irradiated with and scanned by light originated from an illumination lamp. Subsequently, light reflected by the document is imaged on a color sensor after passing through a group of mirrors and lenses. Color image information of the document is subsequently read by the color sensor per RGB (red, green, and blue), and is converted into electrical signals, respectively. Then, based on the RGB color resolution image signals, a color conversion process, a color correction process, and a spatial frequency correction process or the like are implemented in an image processing section, thereby obtaining color image information of yellow, magenta, cyan, and black colors.

Subsequently, the image information pieces of yellow, magenta, cyan, and black colors are transmitted to the optical writing unit 6. Then, the optical write unit 6 emits laser light beams (i.e., exposure light beams) toward the respective photoconductors 11 of the corresponding process cartridges 10Y, 10M, 10C, and 10BK based on the respective color image information pieces.

Meanwhile, the four photoconductors 11 rotate clockwise as shown in the drawing. Accordingly, first of all, surfaces of the photoconductor 11 are electrically charged uniformly (in electric charging processes) by the electric charging rollers 12a provided in the electric charging units 12 (as shown in FIG. 2) at positions opposite to the electric charging rollers 12a, respectively. Hence, electric charge potentials are respectively generated on the surfaces of the photoconductors 11 in this way. The respective surfaces of the photoconductors 11 charged in this way then reach illumination positions to receive the laser light beams. In the optical writing units 6, the laser light beams are emitted from light sources in accordance with the image signals corresponding to respective component colors. Each of the laser light beams passes through each of corresponding multiple lenses after entering and is reflected by a polygon mirror as in a conventional optical system. Each of the laser beams passing through the multiple lenses further goes through each of separate optical paths for yellow, magenta, cyan, and black component colors, respectively (i.e., in respective exposing processes).

More specifically, the laser light of the yellow component is emitted to the surface of the photoconductor 11 provided in the process cartridge 10Y located at a first place from a left side in the drawing. At this moment, the laser light of the yellow component is used in scanning the photoconductor 11 in an axial direction of the photoconductor 11 (i.e., a main scanning direction) by using the polygon mirror rotating at high speed. In this way, on the photoconductor 11 electrically charged by the electric charging roller 12a, an electrostatic latent image of a yellow component is formed.

Similarly, the laser light beam of the cyan component is also emitted to the surface of the photoconductor 11 provided in the process cartridge 10C located at a second place from the left side in the drawing, thereby forming an electrostatic latent image of a cyan component color. The laser light beam of the magenta component is also emitted to the surface of the photoconductor 11 provided in the process cartridge 10M located at a third place from the left side in the drawing, thereby forming an electrostatic latent image of a magenta component color. Again, the laser light beam of the black component is similarly emitted to the surface of the photoconductor 11 provided in the process cartridge 10BK located at a fourth place (as a black image forming unit) from the left side in the drawing (i.e., the most downstream in a running direction of the intermediate transfer belt 17), thereby forming an electrostatic latent image of a black component color.

After that, the surfaces of the photoconductors 11, on which the electrostatic latent images of respective component colors are formed, reach positions opposite the developing units 13 (as shown in FIG. 2), respectively. Subsequently, the developing units 13 supply respective component color toner particles to the photoconductors 11, thereby developing the electrostatic latent images on the photoconductors 11 (i.e., in developing processes), respectively. After completing the developing processes, the surfaces of the photoconductors 11 respectively reach opposite positions to the intermediate transfer belt 17, respectively. At the opposite positions, multiple primary transfer rollers 14 are arranged to contact an inner surface of the intermediate transfer belt 17, respectively. Hence, at positions, at which primary transfer rollers 14 are respectively located, the multiple color toner images formed and borne on the photoconductors 11 are transferred and superimposed sequentially (i.e., in primary transfer processes) on the intermediate transfer belt 17.

Meanwhile, the surfaces of the photoconductors 11 completing the primary transfer processes reach positions opposite the cleaning units 15 (at which multiple cleaning blades 15a are installed as shown in FIG. 2), respectively. Thus, untransferred toner particles remaining on the respective photoconductors 11 are collected by the cleaning units 15, (i.e., in cleaning processes). Then, the surfaces of the photoconductors 11 pass electric charge removing positions, at which electric charge removing sections are located to remove electric charge remaining on the respective surfaces of the photoconductors 11, thereby completing multiple series of image forming processes on the photoconductors 11, respectively.

Meanwhile, the surface of the intermediate transfer belt 17, onto which the multiple images of respective component colors are repeatedly primarily transferred from the photoconductors 11, travels in a direction as shown by arrow in the drawing and reaches a secondary transfer position at which a secondary transfer roller 18 is located. Subsequently, at the position, since the secondary transfer roller 18 is located, the full-color image borne on the intermediate transfer belt 17 is secondarily transferred at once onto a recording medium P (i.e., in a second transfer process). The surface of the intermediate transfer belt 17 subsequently reaches an intermediate transfer belt cleaning position at which an intermediate transfer belt cleaner 9 is located. Hence, untransferred toner remaining on the intermediate transfer belt 17 is collected by the intermediate transfer belt cleaner 9 at the intermediate transfer belt cleaning position, thereby completing a series of toner image transfer processes to be executed on the intermediate transfer belt 17.

Here, the recording medium P sent to the secondary transfer position, at which the secondary transfer roller 18 located, is a recording medium originated and conveyed from a sheet feeding unit 7 via a paper sheet conveyance guide and a pair of registration rollers 19 or the like. Specifically, the recording medium P is fed by a paper sheet feeding roller 8 from the sheet feeding unit 7 that stores multiple recording media P and is led to the pair of registration rollers 19 after passing through the paper sheet conveyance guide. The recording medium P having reached the pair of registration rollers 19 is further conveyed toward the secondary transfer position of the secondary transfer roller 18 at a prescribed time to match (i.e., synchronize) with the full-color toner image borne on the intermediate transfer belt 17.

After that, the recording medium P with the full-color image transferred thereonto is led to the fixing unit 20. The full-color image is then fixed into the recording medium P at a fixing nip formed between a fixing roller and a pressing roller provided in the fixing unit 20 in a fixing process. Subsequently, the recording medium P completing the fixing process is ejected by a pair of sheet ejection rollers 29 and stacked onto a sheet ejection unit 5 located outside the apparatus main body 1 of the image forming apparatus as an output of an image, thereby completing a series of image formation processes.

Now, an image forming unit provided in the image forming apparatus is described in greater detail with reference to FIG. 2. That is, FIG. 2 typically illustrates an exemplary process cartridge 10BK of a black component color. Since the other three remaining process cartridges 10Y, 10M, and 10C have almost the same constructions and similarly operate as the process cartridge 10BK for the black component color except for color of toner used in an image formation process, illustrations and descriptions of those are omitted herein below for the simplicity.

Specifically, as shown in FIG. 2, in the process cartridge 10BK, the photoconductor 11 (the image bearer 11), the electric charging unit 12 that electrically charges the photoconductor 11, a developing unit 13 that develops an electrostatic latent image formed and borne on the photoconductor 11, and a cleaning unit 15 that collects untransferred toner borne on the photoconductor 11 are housed integrally.

Here, the photoconductor 11 (as the image bearer 11) is an organic photoconductor having a negative chargeability, which is constituted by a photosensitive layer overlying a drum-shaped conductive substrate and the like. More specifically, the photoconductor 11 is configured by a base layer as the conductive substrate, an under coat layer as an insulating layer overlying the drum-shaped conducting substrate, an electric charge generation layer, an electric charge transport layer collectively acting as a photosensitive layer with the electric charge generation layer, and a protective layer (i.e., a surface layer) each stacked one after another. Here, the conductive substrate (i.e., the base layer) of the photoconductor 11 may be made of conductive material having a volume resistivity of about 10¹⁰Ω.

The electric charging unit 12 is constituted by an electric charging roller 12a and an electric charging roller cleaning roller 12b or the like. The electric charging roller 12a is constituted by a conductive metal core and an elastic layer having a medium resistance covering a perimeter of the conductive metal core. The electric charging roller cleaning roller 12b is provided to contact the electric charging roller 12a to eliminate stains or the like sticking onto the electric charging roller 12a therefrom. Subsequently, in the electric charging unit 12 configured in this way, a given voltage is applied to the electric charging roller 12a from a power source 103 (see FIG. 8), thereby uniformly electrically charging a surface of the photoconductor 11 disposed opposite thereto.

Beside the developing roller 13a opposed to the photoconductor 11, the developing unit 13 (as a developing device) is mainly constituted by a first developer conveyance screw 13b1 facing the developing roller 13a, a second developer conveyance screw 13b2 facing the first developer conveyance screw 13b1 across a partition member, and a doctor blade 13c facing the developing roller 13a. The developing roller 13a includes a magnet secured to an interior of the developing roller 13a to form multiple magnetic poles on a surface of the developing roller 13a. The developing roller 13a also includes a sleeve that rotates around the magnet. Hence, the magnet forms more than two magnetic poles on the surface of the developing roller 13a (i.e., the sleeve) to bear developer on the developing roller 13a. In the developing unit 13, two-component developer consisting of carrier and toner is stored.

Further, in the cleaning unit 15, a cleaning blade 15a or the like is also installed to contact the photoconductor 11. Also disposed in the cleaning unit 15 is a developer conveyance coil 15b acting as a developer conveying device that conveys developer collected by the cleaning unit 15 therein as waste developer (i.e., untransferred developer) in a longitudinal direction thereof toward a waste developer collection container disposed outside the cleaning unit 15. Further disposed in the cleaning unit 15 is a housing 15c that covers the cleaning unit 15. The cleaning blade 15a is mainly configured by a blade portion 15a1 made of polyurethane or the like to serve as a blade main body and a blade holding portion 15a2 (i.e., a blade holder) made of a sheet like metal that holds the blade portion 15a1. The blade portion 15a1 of the cleaning blade 15a is brought into pressure contact with the surface of the photoconductor 11 while making a prescribed angle therewith. Hence, the deposits, such as the untransferred developer, etc., adhering to the surface of the photoconductor 11 is mechanically scraped off by the cleaning blade 15a, thereby being collected by the cleaning unit 15 therein.

Here, as the deposits adhering to the photoconductor 11, beside the untransferred developer, paper dust produced by the recording medium P (i.e., the paper sheet P), discharge products generated on the photoconductor 11 when the electric charging roller 12a provides discharge thereto, and additives adhering to the toner or the like are exemplified. The cleaning unit 15 is described later in further detail.

Now, the above-described image forming processes is described in more detail with reference to FIG. 2. The developing roller 13a rotates counterclockwise, specifically, in a direction as shown by an arrow in FIG. 2. Hence, developer stored in the developing unit 13 circulates in the longitudinal direction (i.e., a direction perpendicular to a plane of a sheet of FIG. 2) while being stirred and mixed together with toner supplied from the toner container 28 provided in a toner supplying unit when the first developer conveyance screw 13b1 and the second the developer conveyance screw 13b2 separated by the partition member rotate at the same time.

Subsequently, toner charged with electricity due to friction with it adheres to a carrier and is collectively borne on the developing roller 13a (i.e., together with the career). The developer borne on the developing roller 13a then reaches a position at which the doctor blade 13c is located. Subsequently, an amount of the developer borne on the developing roller 13a is adjusted at the position opposite the doctor blade 13c. The developer borne on the developing roller 13a then reaches a position opposite the photoconductor 11 (i.e., a developing region).

After that, the toner in the developer adheres to the electrostatic latent image formed on the surface of the photoconductor 11 in the developing region during a developing process. Specifically, since an electric field is formed in the developing region due to a difference in electric potential (i.e., developing potential) between an electrostatic latent image in an image portion irradiated with a laser beam L (i.e., an exposure potential) and a development bias applied to the developing roller 13a, the toner adheres to the electrostatic latent image, thereby forming a toner image thereon.

Then, almost all of the developer adhering to the photoconductor 11 during the developing process is transferred onto the intermediate transfer belt 17. Meanwhile, untransferred developer remaining on the photoconductor 11 is removed by the cleaning blade 15a (i.e., the photoconductor 11 is cleaned) and is collected by the cleaning unit 15 therein.

The toner supplying unit provided in the apparatus main body 1 is configured by multiple bottle type toner containers 28 each freely replaced with a new toner container and multiple toner hopper sections that supply fresh toner particles to the developing units 13 while holding and rotating the toner containers 28, respectively. Hence, in the respective toner containers 28, fresh toner particles (e.g., yellow, magenta, cyan, and black toner particles) are previously contained respectively. On an inner circumferential wall surface of each of the toner containers 28 (i.e., the toner bottle), a spiral-shaped protrusion is formed.

Hence, the fresh toner particles stored in the toner containers 28 are supplied to the respective developing units 13 from toner supply ports as needed as the toner particles stored in the developing units 13 (i.e., existing toner particles) are consumed. The consumption of toner stored in each of the developing units 13 is detected either directly or indirectly by using a reflective photo sensor and a magnetic sensor or the like installed below the second developer conveyance screw 13b2 facing the photoconductor 11 in each of the developing units 13.

In the above-described exemplary image forming unit, since the electric charging roller 12a does not contact the photoconductor 11, the photoconductor 11 is only contacted by the cleaning blade 15a and the intermediate transfer belt 17. Hence, as shown in FIG. 3A, when the photoconductor 11 rotates, the cleaning blade 15a receives a driving torque therefrom and provides an upward force in response as a resisting (or reaction) force (i.e., a force caused by friction generated therebetween). Consequently, when the photoconductor 11 is relatively thin having a small diameter capable of accommodating a continuous paper sheet (i.e., a small-diameter, thin, and continuous-paper-sheet-accommodating photoconductor 11 is used), the photoconductor 11 deflects by several dozens of micrometers (ums) as shown in FIG. 3B. Consequently, a gap between the photoconductor 11 and the electric charging roller 12a is widened at a central portion of the photoconductor 11 in a longitudinal direction (i.e., in an axis direction) thereof, thereby raising a problem as described later in detail. In view of this, to obtain a desired function of the electric charging roller 12a, a system capable of equalizing a size of the gap non-uniformly extending between the electric charging roller 12a and the photoconductor 11 in the longitudinal direction of those is needed as a countermeasure against the above-described problem.

Further, when the electric charging roller 12a is disposed to contact the photoconductor 11 and an AC (Alternating Current) bias voltage is superimposed on the electric charging roller 12a, it is known that a resistance of the electric charging roller is generally affected by a change in environment. However, if constant current control is implemented to render the AC current constant, the resistance of the electric charging roller is hardly affected by the change in environment. In such a situation, however, when the electric charging roller 12a is disposed while separating from the photoconductor 11 and the AC bias voltage is again superimposed on the electric charging roller 12a, since an electric charge gap changes as the photoconductor 11 and the electric charging roller 12a rotate, a high voltage power source 103 cannot correspond to the change in electric charge gap during the AC constant current control, thereby sometimes generating an abnormal image (e.g., density unevenness causing a lateral streak) due to occurrence of either overshoot or undershoot. For this reason, the AC voltage is desirably subjected to constant voltage control (of a voltage controller 100). In such a situation, however, the AC voltage needs to vary in accordance with both a change in resistance of the (electric charging) roller 12a caused by the change in environment and that in size of the electric charge gap as well. That is, the higher the resistance of the (electric charging) roller 12a, the higher the AC voltage required. Also, the wider the electric charge gap, the higher the AC voltage required as well.

When a central portion of an image in a longitudinal direction thereof, at which the size of the gap is the greatest, lacks a value of discharge applied by the electric charging roller 12a, an anomaly image, such as a spotty image, etc., again occurs there. Otherwise, a discharge amount becomes excessive at an edge of the image in the longitudinal direction thereof, thereby producing deposits on the photoconductor 11 (e.g., the OPC) while sometimes causing a drop of toner from the image as well. To solve such a problem, this embodiment of the present invention employs a gap system having a gap keeping member to form and keep a prescribed size of a gap as an electric charge gap between a roller-shaped electric charging member (i.e., the electric charging roller 12a) and the image bearer 11.

Further, as shown in FIG. 8, this embodiment of the present invention also employs a discharge current detector 102 and a discharge current value calculator 101 that collectively calculate a value of discharge current generated by the electric charging unit 12 (i.e., the electric charging roller 12a) under a condition in that the gap system almost uniformly keeps the prescribed size of the electric charge gap in the longitudinal direction. Specifically, a voltage Vpp (i.e., an applied voltage to the electric charging roller 12a) is changed to render a value of the discharge current almost constant in this embodiment of the present invention. That is, to solve the above-described problems, in addition to reduction of the unevenness of the gap size (i.e., gap size variation) in the longitudinal direction of the image bearer 11 and the electric charging roller 12a as well, an optimum AC voltage serving as the applied voltage is applied to the electric charging roller 12a to reduce unevenness of the discharge current caused as the image bearer 11 and the electric charging roller 12a rotate due to a fluctuation in discharge gap caused at the same time in a circumferential direction due to a fluctuation in electric charge gap in the same direction.

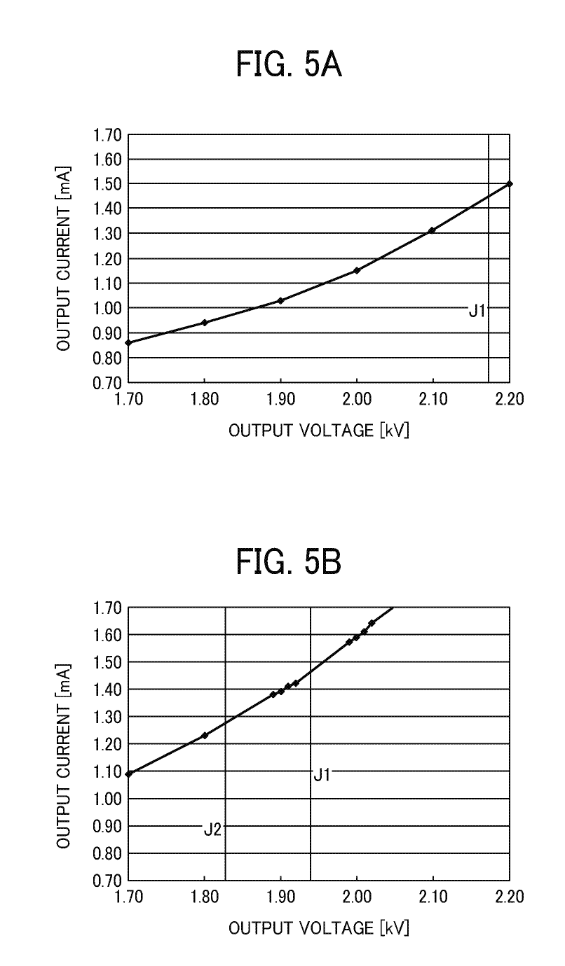

Here, FIG. 5A illustrates an exemplary relation between a value of current (flowing from the electric charging roller 12a) and an applied voltage thereto generating the value of current when a size of the gap is an upper tolerance limit. FIG. 5B also illustrates an exemplary relation between the value of current (flowing from the electric charging roller 12a) and an applied voltage generating the value of current when the size of the gap is a lower tolerance limit. In these drawings, respective solid vertical lines J1 represent voltages Vpp generating a prescribed (upper limit) target current value (e.g., about 1.45 mA) (flowing from the electric charging roller 12a) when the size of the gap is the upper tolerance limit. Similarly, a solid vertical line J2 shown in FIG. 5B represents a voltage Vpp generating another prescribed (lower limit) target current value (e.g., about 1.275 mA) (flowing from the electric charging roller 12a) when the size of the gap is the lower tolerance limit. Here, a parameter that extremely contributes to an electric charging function is the gap when the non-contact type electric charging system is employed. Accordingly, to prevent an abnormal image in every situation, the current value is necessarily determined by a PCU premising that the gap is widest. As a result, when the size of the gap is the lower tolerance limit, an excessive voltage Vpp of about 110 V (J1-J2) is applied by the PCU, thereby possibly raising a problem.

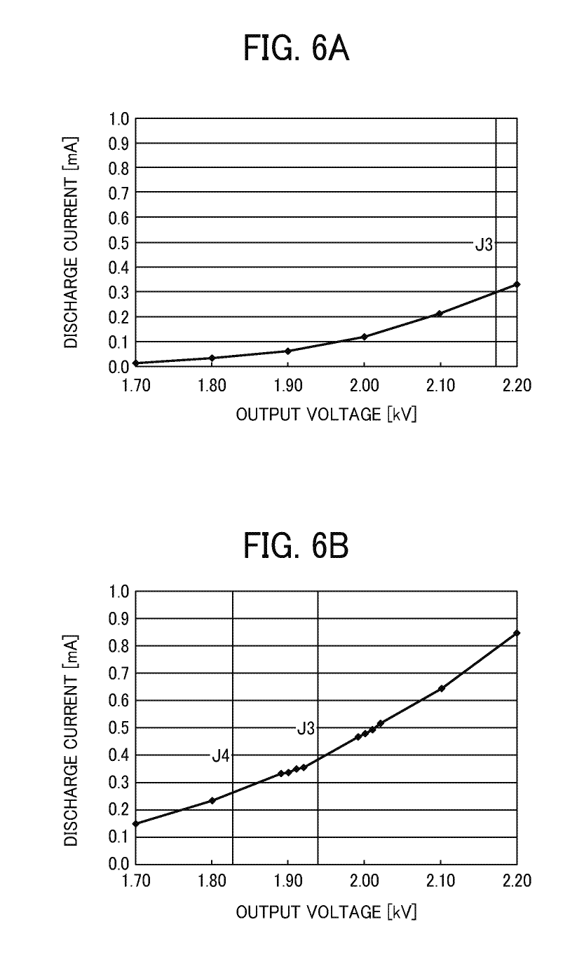

By contrast, FIG. 6A illustrates an exemplary relation between a value of discharge current and an applied voltage when the size of the gap is the upper tolerance limit. FIG. 6B also illustrates an exemplary relation between the value of discharge current and the applied voltage when the size of the gap is the lower tolerance limit. In these drawings, respective solid vertical lines J3 represent voltages Vpp that generate a prescribed value of a (upper limit) target discharge current (e.g., about 0.3 mA) flowing from the electric charging roller 12a when the size of the gap is the upper tolerance limit. Similarly, a solid vertical line J4 shown in FIG. 6B represents a voltage Vpp that generates another prescribed value of a (lower limit) target discharge current (e.g., about 0.25 mA) flowing from the electric charging roller 12a when the size of the gap is the lower tolerance limit. As understood therefrom, when the size of the gap is the lower tolerance limit, a Vpp component excessively applied by the PCU is about 40 V (J1-J2) and is relatively smaller than that excessively applied by the PCU when current adjustment is executed as shown in FIG. 5B. That is, as noted heretofore, by employing discharge current adjustment as shown in FIG. 6B (as is different from the current adjustment), the hazard applied the photoconductor 11 can be more effectively reduced in the non-contact type electric charging system.

Further, as shown in FIG. 9, when the roller-shaped electric charging member (i.e., the electric charging roller 12a) is located below a central axis of the photoconductor 11, the electric charging roller 12a desirably has a drum shape having a larger diameter at a central portion than a diameter of each of the edge portions thereof (i.e., thicker at the central portion thereof). By contrast, when the roller-shaped electric charging member (i.e., the electric charging roller 12a) is located above the central axis of the photoconductor 11, the electric charging roller 12a has desirably the drum shape having a smaller diameter at the central portion than a diameter of each of edge portions thereof (i.e., thinner at the central portion thereof). With this, since the gap size variation in the longitudinal direction can be effectively reduced by a simple structure and the hazard to the photoconductor 11 can be also effectively reduced as well, a margin to allow deposits, such as killifish-shaped filming, etc., on the photoconductor 11 can be effectively increased. That is, even if the gap size variation in the circumferential direction and variation of a gap center value thereof are reduced as much as possible, a more than necessary hazard is necessarily yet applied to the end of the photoconductor 11 if the gap size variation remains in the longitudinal direction. As a result, with such a configuration, the above-described reduction of the gap size variation in the circumferential direction and the variation of the gap center value thereof are not very much effective to reduction of the hazard to the photoconductor. By contrast, however, according to one embodiment of the present invention, with the above-described configuration, the gap size variation in the longitudinal direction can be effectively reduced by a simple configuration.

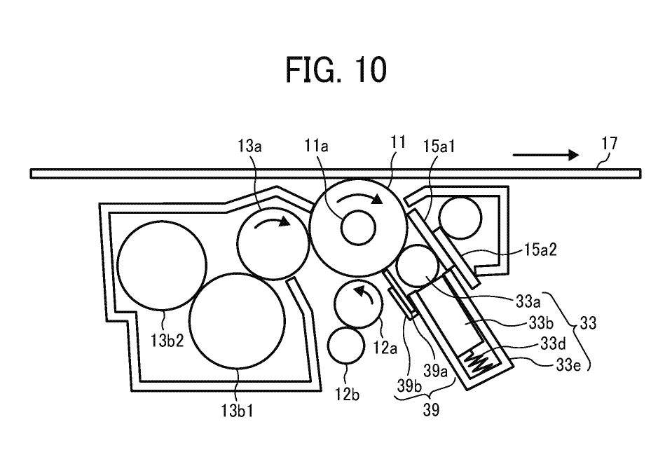

Further, in an interior of the OPC (i.e., the photoconductor 11), a penetrating shaft 11a (see FIG. 10) is desirably provided. That is, with this, since the gap size variation in the longitudinal direction can be effectively reduced by such a simple structure and the hazard to the photoconductor 11 can be reduced at the same time as well, the margin to allow deposits, such as killifish-shaped filming, etc., on the photoconductor 11 can be effectively increased. That is because, deflection of the photoconductor 11 can be effectively reduced.

Further, a prescribed lubricant 31b is desirably applied to a surface of the OPC (i.e., the photoconductor 11). With this, since the gap size variation in the longitudinal direction can be also effectively reduced again by such a simple structure and the hazard to the photoconductor can be reduced at the same time as well, the margin to allow deposits, such as killifish-shaped filming, etc., on the photoconductor again effectively can increase. That is because, a resistance caused due to sliding contact of the blade 15a with the photoconductor 11 and accordingly deflection of the photoconductor 11 can be effectively reduced at the same time as well.

Further, a lubricant 31b containing boron nitride (BN) is also desirably applied onto the photoconductor 11. Since the gap size variation in the longitudinal direction can be effectively reduced by such a simple structure and the hazard to the photoconductor 11 can be reduced as well, a margin to allow deposits, such as killifish-shaped filming, etc., on the photoconductor 11 can be effectively increased. That is, since a resistance caused due to sliding contact of the blade 15a with the photoconductor 11 is reduced, the deflection of the photoconductor 11 can be also reduced at the same time, and accordingly the gap size variation in the longitudinal direction can be effectively reduced with such a simple configuration.

Further, an environment is desirably classified into several sections per absolute humidity. Specifically, each of the target discharge currents (e.g., upper and lower target discharge currents) is determined in accordance with the environment classification to change a voltage Vpp in accordance with the target discharge current as well. With this, since the hazard to the photoconductor 11 is effectively reduced, the margin to allow deposits, such as killifish-shaped filming, etc., on the photoconductor 11 can be effectively increased again as well.

Further, a discharge current value is desirably sought by the below described method, for example. That is, a composite high-voltage power source (HVP) 103 is used and at least one current value is thereby sought at a voltage Vpp at which discharge current does not flow. At least one the other current value is also sought by using composite high-voltage power source (HVP) 103 at a voltage Vpp at which discharge current occurs. The discharge current value is then obtained based on these two current values detected in this way while subtracting a displacement current component therefrom. That is, when the electric discharge does not appear, a value of flowing current can be expressed by the following equation, wherein Vpp is a voltage applied to the electric charging roller while drawing a sine curve, f is a frequency, and C is a capacity of a condenser,

I=√2πfC×Vpp.

When a value of Vpp is represented by V₁ and a value of current is represented by I₁ when the electric discharge does not occur, and a value of Vpp is represented by V₂, a value of current is represented by I₂, and a value of electric discharge current is represented by I₃ when the electric discharge occurs, the following equations are established,

I₁=√2πfC×V₁,

and

I₂=√2πfC×V₂+I₃.

Hence, the value of electric discharge current I₃ can be obtained by calculating the following formula,

I₃=I₂−I₁/V₂×V₂.

With this, since the hazard to the photoconductor 11 is effectively reduced with a simple configuration, the margin to allow deposits, such as killifish-shaped filming, etc., on the photoconductor 11 can be effectively increased again. Here, such a V-I (Voltage versus Current) characteristic can be measured by using a currently available system when the composite high-voltage power source 103 is employed. Hence, by calculating the discharge current value based on at least two current values, the hazard to the photoconductor 11 can be effectively reduced again without unnecessarily wasting a cost and a waiting time as well.

Further, the calculation of the discharge current value may be based on a current value flown into an earth of the photoconductor and read by an electric discharge current detector 102 (see FIG. 8) acting as a current value reading system as well. With this, since accuracy of detection of the discharge current value is effectively improved and both a control error and the hazard to the photoconductor are effectively reduced at the same time, the margin to allow deposits, such as killifish-shaped filming, etc., on the photoconductor can be effectively increased again.

Further, as shown in FIG. 8, a detection time determiner 101 may be employed to determine a time when the discharge current value is detected as described below. That is, for example, the discharge current value is only detected at a time when a transfer device does not apply a primary transfer current (to the photoconductor 11). With this, since the accuracy of detection of the discharge current value is effectively upgraded while reducing the hazard to the photoconductor 11 as well, the margin to allow deposits, such as killifish-shaped filming, etc., on the photoconductor 11 can be effectively increased again. That is, for example, when the primary transfer current is applied (to the photoconductor 11), a pre-transfer potential is affected by a transfer process (the primary transfer current) and fluctuates. Such a fluctuation of the pre-electric charge voltage changes a discharge starting gap, thereby deteriorating accuracy of detection of the discharge current value. By contrast, according to this modification of the embodiment of the present invention, accuracy of detection of the discharge current value is more effectively improved when the transfer device does not apply a primary transfer current (to the photoconductor 11) than when it applies the primary transfer current thereto.

Otherwise, the discharge current can be detected when an image formation job is completed as well. With this, accuracy of detection of the discharge current is more effectively reduced than when the primary transfer current is applied (to the photoconductor 11). In addition, since a simple structure is employed to detect the discharge current again, accuracy of detection of the discharge current can be effectively upgraded as well.

Yet otherwise, the discharge current can be also detected at a time when an interval of successively fed sheets P comes to the transfer section as well. With this, accuracy of detection of the discharge current is more effectively upgraded than when the primary transfer currents is applied (to the photoconductor 11) again.

Hence, with each of the above-described simple structures, since accuracy of detection of the discharge current is effectively upgraded while reducing the hazard to the photoconductor 11, the margin to allow deposits, such as killifish-shaped filming, etc., on the photoconductor can be effectively increased again.

Further, a quotient of a frequency of an AC voltage applied to the electric charging roller divided by a linear velocity (of the electric charging roller 12a) may be set to about six or more (i.e., six times or more). With this, since an absolute value of the discharge current increases, and accordingly a detection error relatively decreases, accuracy of detection of the discharge current can be effectively upgraded again. In addition, since the hazard to the photoconductor 11 is reduced again, the margin to allow deposits, such as killifish-shaped filming, etc., on the photoconductor 11 can be effectively increased as well.

That is, according to this modification of one embodiment of the present invention, since detection error relatively decreases more effectively than when the value of discharge currents is relatively small, accuracy of detection of the discharge current can be again effectively reduced, and accordingly a spatial frequency, at which unevenness of discharge is invisible, can be set as well.

Further, an internal memory may be included in the image forming unit. Specifically, the photoconductor 11 is previously rotated the least common multiple times (so that the photoconductor and the charging roller each rotate different integer number of times) to acquire and store information of a change in discharge current value caused in the circumferential direction in the internal memory beforehand. Then, the PCU may control the applied voltage Vpp in accordance with the discharge current value stored in the internal memory. Hence, even in a simple structure that employs a non-contact type electric charging roller, in which a surface of the photoconductor 11 is rarely scraped off and the above-described load rarely varies, thereby hardly contaminating the electric charging roller 12a, since the hazard to the photoconductor 11 is reduced, the margin to allow deposits, such as killifish-shaped filming, etc., on the photoconductor can be effectively increased again.

Now, various embodiments of the present invention are described herein below in more detail.

Initially, various factors constituting the various embodiments of the present invention are herein below described more in detail. First, the below described first table shows a diameter, a thickness, a secondary moment of area, and a length of the OPC (i.e., the photoconductor 11). A symbol ̂ described therein is used to represent an exponential. In addition, a code E represents an exponent as well.

FIRST TABLE

| | | Secondary | | Secondary |
|---|---|---|---|---|
| Diameter | Thickness | moment of area | Length | moment of area/ |
| (mm) | (mm) | (mm \hat{ } 4) | (mm) | Length \hat{ } 3 (mm) |
| About 30 | About 0.75 | About 7375.4 | About 376 | About |
| | | | | 1.3875E−04 |

The diameter, the thickness, and the length of the OPC (i.e., the photoconductor 11) serve as factors that respectively affect a material cost of the OPC (i.e., the photoconductor 11). Hence, a secondary moment of area (I) of the OPC (i.e., the photoconductor 11) can be expressed by the below described formula-1 to represent a difficult degree of deflection thereof:

I=(Outer diameter̂4×π−Inner diameter̂4×π)/64 (Formula-1).

Further, an amount of deflection (y) of the OPC (i.e., the photoconductor 11) can be expressed by the below described formula-2.

y=WL³/48EI=W/48E×L³/I (Formula-2).

Hence, the larger the quotient of the secondary moment of area divided by the third power of the length, the harder the OPC (i.e., the photoconductor 11) deflects.

Among the above-described various factors, the length of the OPC (i.e., the photoconductor 11) is hardly decreased, because an image needs to be printed on the continuous paper sheet having a prescribed length. Although the secondary moment of area of the OPC can be increased by increasing the diameter and the thickness of the OPC, they cannot be practically increased because these factors prevent the image forming apparatus or a process cartridge from downsizing and weight saving thereof.

However, when a quotient of the secondary moment of area of the OPC divided by the third power of the length thereof is too small (e.g., 0.00005 or less), deflection of the OPC significantly grows (e.g., 50 μm or more) when the friction is applied thereto by cleaning blade 15a. As a result, even when the above-described crown shaped electric charging roller 12a is used, it cannot yet satisfy required properties, such as an averaged electric charging gap of about 50 μm or less, a gap size variation of about 20 μm or less in a longitudinal direction of the OPC, no contact of the electric charging roller with the OPC when they are stopped rotating, etc.

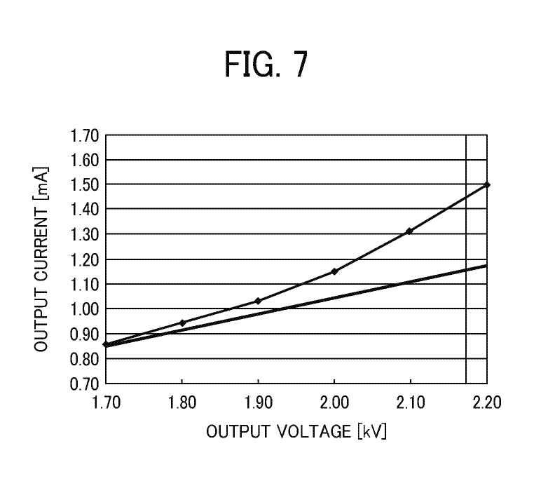

Further, the above-described discharge current can be also calculated by the below described method as well. That is, as shown in FIG. 7, a relation between an applied voltage Vpp (an output voltage) and an output current is previously obtained. Then, approximation processing is applied to a liner portion of a functional curve that shows the relation between the applied voltage Vpp and the output current, and a difference from the output current is sought to obtain the discharge current. Such a calculation can be achieved by an operation function of a microcomputer or the like installed in the image forming apparatus.

As described heretofore, various embodiments of the present invention can be generally applied to an image forming apparatus, such as a copier, a printer, a scanner, a facsimile machine, and a multifunctional machine configured by combining functions of these apparatuses, etc.

According to one aspect of the present invention, to reduce an amount of stein on an electric charging roller and suppresses irregularity of discharge current possibly caused when a discharge gap varies in a circumferential direction of the electric charging roller as an electric charge gap varies in the circumferential direction, thereby significantly reducing a hazard to the photoconductor as well, longitudinal variation of the gap is first reduced and then an optimum AC voltage is selectively applied to the electric charging roller at the same time. That is, a fine image can be output for a long period of time while inhibiting occurrence of abnormal discharge that generally occurs as time elapses. That is, according to one aspect of the present invention, an image forming apparatus includes an image bearer 11 having a secondary moment of area and a length so that a quotient of the secondary moment of area divided by a third power of the length ranges from about 0.00005 to about 0.00015. The image forming apparatus also includes an electric charging member to electrically charge the image bearer 11 uniformly across an electric charge gap, a voltage applying device to apply a voltage to the electric charging member, and a writing device to write and form an electrostatic latent image on the image bearer 11. The image forming apparatus further includes a developing device to render the electrostatic latent image visible as a toner image, a transfer device disposed in a transfer section to transfer the toner image rendered visible by the developing device onto a recording medium, and a cleaner to collect residual toner remaining on the image bearer 11 therefrom after the transfer device transfers the toner image onto the recording medium. The image forming apparatus further includes an electric charge gap maintaining device to form and keep constant the electric charge gap between the electric charging member and the image bearer 11, a calculating device to calculate a value of discharge current generated by the electric charging member, and a processor controls the voltage applying device to vary a voltage applied to the electric charging device to render the value of discharge current calculated by the calculating device substantially constant.

Numerous additional modifications and variations of the present invention are possible in light of the above teachings. It is therefore to be understood that within the scope of the appended claims, the present invention may be executed otherwise than as specifically described herein. For example, the image forming apparatus is not limited to the above-described various embodiments and modifications and may be altered as appropriate. Further, the process cartridge is not limited to the above-described various embodiments and modifications and may be altered as appropriate. Furthermore, the method of forming an image is not limited to the above-described various embodiments and may be altered as appropriate. For example, steps of the method of forming an image can be altered as appropriate.

What is claimed is:

1. An image forming apparatus comprising:
an image bearer to bear an image thereon;
an electric charging member, spaced apart from the image bearer across an electric charge gap, to electrically charge the image bearer uniformly across the electric charge gap;
a voltage applying device to apply a voltage to the electric charging member;
a writing device to write and form an electrostatic latent image on the image bearer;
a developing device to render the electrostatic latent image visible as a toner image;
a transfer device, disposed in a transfer section of the image formation apparatus, to transfer the toner image rendered visible by the developing device onto a recording medium;
a cleaner to collect residual toner remaining on the image bearer therefrom after the transfer device transfers the toner image onto the recording medium;
an electric charge gap maintaining device to form and keep constant the electric charge gap between the electric charging member and the image bearer;
a calculating device to calculate a value of discharge current to be generated by the electric charging member; and
a processor to control the voltage applying device to vary a voltage applied to the electric charging device to render the value of discharge current calculated by the calculating device substantially constant.

2. The image forming apparatus as claimed in claim 1, wherein the image bearer is a small-diameter, thin, and continuous-paper-sheet-accommodating photoconductor.

3. The image forming apparatus as claimed in claim 1, wherein the image bearer has a secondary moment of area and a length,
wherein a quotient of the secondary moment of area divided by a third power of the length ranges from about 0.00005 to about 0.00015.

4. The image forming apparatus as claimed in claim 1, wherein the cleaner is a cleaning blade,
wherein a leading edge of the cleaning blade is brought into frictional contact with a surface of the image bearer,
wherein the cleaning blade extends from a base thereof in an opposite direction to a rotational direction of the image bearer at a contact position therebetween.

5. The image forming apparatus as claimed in claim 1, wherein the electric charging member is an electric charging roller,
wherein the electric charging roller is located either above the image bearer, or below the image bearer,
wherein the electric charging roller has a drum shape having either a larger diameter at a central portion thereof than that of an edge thereof when located below the image bearer across the electric charge gap maintaining device or a smaller diameter at a central portion thereof than that of the edge thereof when located above the image bearer across the electric charge gap maintaining device.

6. The image forming apparatus as claimed in claim 1, wherein the image bearer is an organic photoconductor,
wherein the organic photoconductor accommodates a shaft that penetrates the organic photoconductor.

7. The image forming apparatus as claimed in claim 6, wherein a surface of the organic photoconductor is coated with lubricant.

8. The image forming apparatus as claimed in claim 1, wherein the image bearer is coated with a lubricant containing boron nitride.

9. The image forming apparatus as claimed in claim 1, wherein a target discharge current is determined by the processor in accordance with an absolute humidity,
wherein the voltage applied to the electric charging member is changed by the processor in accordance with the target discharge current.

10. The image forming apparatus as claimed in claim 1, further comprising a composite high voltage power source,
wherein the processor calculates the discharge current value based on at least two current values by subtracting a displacement current component therefrom, the at least two current values being detected by the processor when the composite high voltage power source applies a first voltage and a second voltage to the electric charging member, the first voltage not causing discharge therefrom, the second voltage causing the discharge therefrom.

11. The image forming apparatus as claimed in claim 1, wherein the processor reads a value of current flowing to ground from the image bearer and the calculating device calculates the discharge current value based on the value of current read by the processor.

12. The image forming apparatus as claimed in claim 1, wherein the calculating device calculates the value of discharge current based on a difference between a function curve that shows a relation between an output current and an output voltage applied to the electric charging member and an approximation straight line drawn at a linear portion of the function curve.

13. The image forming apparatus as claimed in claim 1, wherein the processor detects the discharge current value when the transfer device does not apply a primary transfer current to the image bearer.

14. The image forming apparatus as claimed in claim 13, wherein the processor detects the discharge current value when an image formation job is completed.

15. The image forming apparatus as claimed in claim 1, wherein the processor detects the discharge current value in an interval between successively fed sheets in the transfer section.

16. The image forming apparatus as claimed in claim 1, wherein the voltage applied to the electric charging member is an AC voltage and a quotient of a frequency of the AC voltage divided by a linear velocity of the electric charging member is about six or more.

17. The image forming apparatus as claimed in claim 5, further comprising:
a memory;
a power control unit to rotate the image bearer and the electric charging roller the least common multiple times thereof,
wherein the processor acquires and stores, in the memory, information of a change in discharge current value caused in a circumferential direction of the electric charging member when the power control unit rotates the image bearer and the electric charging roller the least common multiple times thereof,
wherein the processor controls the voltage applying device to apply the voltage to the electric charging roller in accordance with the discharge current value stored in the memory.

18. A process cartridge detachably attached to the image forming apparatus as claimed in claim 1,
wherein the process cartridge accommodates at least the image bearer and the cleaner to clean the image bearer as a unit.

19. The process cartridge as claimed in claim 18, wherein the process cartridge additionally accommodates one of the electric charging member, the writing device, the developing device, and the transfer device,
wherein the writing device is an exposing member.

20. A method of forming an image, comprising the steps of:
bearing an image on an image bearer having a secondary moment of area and a length with a quotient of the secondary moment of area divided by a third power of the length ranging from about 0.00005 to about 0.00015;
electrically charging the image bearer uniformly with an electric charging member across an electric charge gap;
applying a voltage to the electric charging member with a voltage applying device;
optically writing and forming an electrostatic latent image on the image bearer with an optical writing unit;
rendering the electrostatic latent image visible as a toner image with a developing device;
transferring the toner image rendered visible during the step of rendering the electrostatic latent image visible with the developing device onto a recording medium with a transfer device disposed in a transfer section;
collecting residual toner remaining on the image bearer with a cleaner therefrom after the step of transferring the toner image onto a recording medium with a transfer device;
forming and keeping constant the electric charge gap between the electric charging member and the image bearer with an electric charge gap maintaining device;
calculating a value of discharge current to be generated by the electric charging member with a calculating device; and
controlling the voltage applying device with a processor to vary and apply the voltage to the electric charging member to render the value of discharge current constant based on a result of calculation executed during the step of calculating the value of discharge current to be generated by the electric charging member with the calculating device.
